(19) United States
(12) Patent Application Publication
(10) Pub. No.: US 2024/0386437 A1
(43) Pub. Date: Nov. 21, 2024

(54) METHOD FOR MODEL-BASED REAL-TIME CONCERN RESOLUTION

(71) Applicant: Gigabite Inc., Miami, FL (US)

(72) Inventors: Sándor Muraközi, Budapest (HU); Gábor Takács, Budapest (HU); Daniel Petz, Miami, FL (US); Stuart Murless, Miami, FL (US)

(21) Appl. No.: 18/667,329

(22) Filed: May 17, 2024

Related U.S. Application Data
(60) Provisional application No. 63/467,842, filed on May 19, 2023.

(51) Int. Cl. G06Q 30/015; G10L 15/06; G10L 15/08; G10L 25/63

(52) U.S. Cl. CPC G06Q 30/015; G10L 15/063; G10L 15/08; G10L 25/63

(57) ABSTRACT

A method includes, during a telecommunication session between a first device associated with a organization and a second device associated with an entity: accessing a set of audio data in an audio data stream of the telecommunication session; detecting a set of language signals based on the set of audio data; accessing a model correlating language signals with concepts and sentiment values associated with concepts; based on the model, correlating the set of language signals with a first concept and a first sentiment value associated with the first concept; based on the first concept and the first sentiment value, identifying a subset of responses predicted to result in a second sentiment value associated with the first concept, the second sentiment value exceeding the first sentiment value; generating a notification specifying the first concept and the subset of responses; and serving the notification at the first device.

### CROSS-REFERENCE TO RELATED APPLICATIONS

This application claims the benefit of U.S. Provisional Application No. 63/467,842, filed on 19 May 2023, which is incorporated in its entirety by this reference.

### BRIEF DESCRIPTION OF THE FIGURES

FIG. 1 is a flowchart representation of a method; and

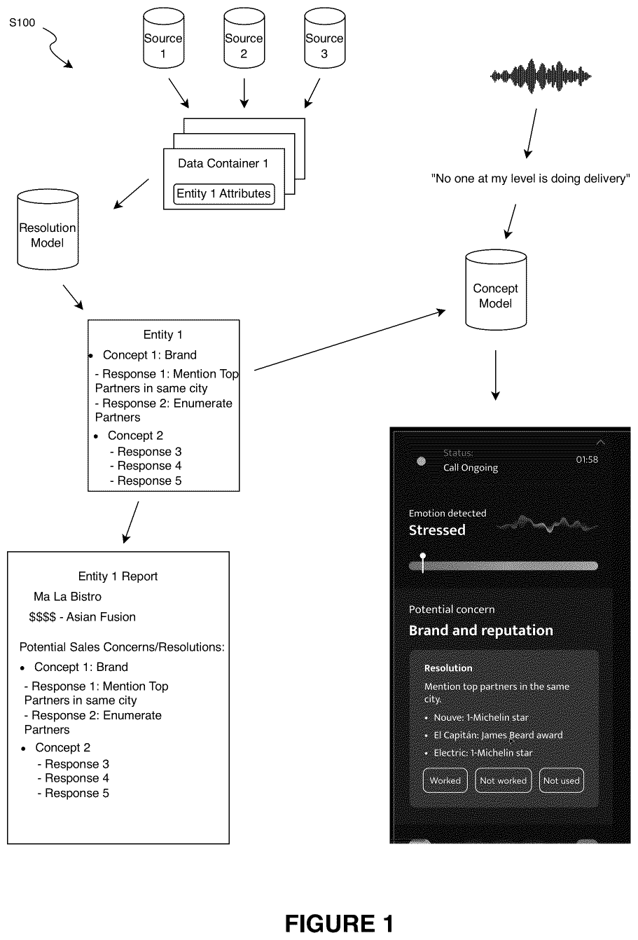

FIG. 2 is a flowchart representation of one variation of the method.

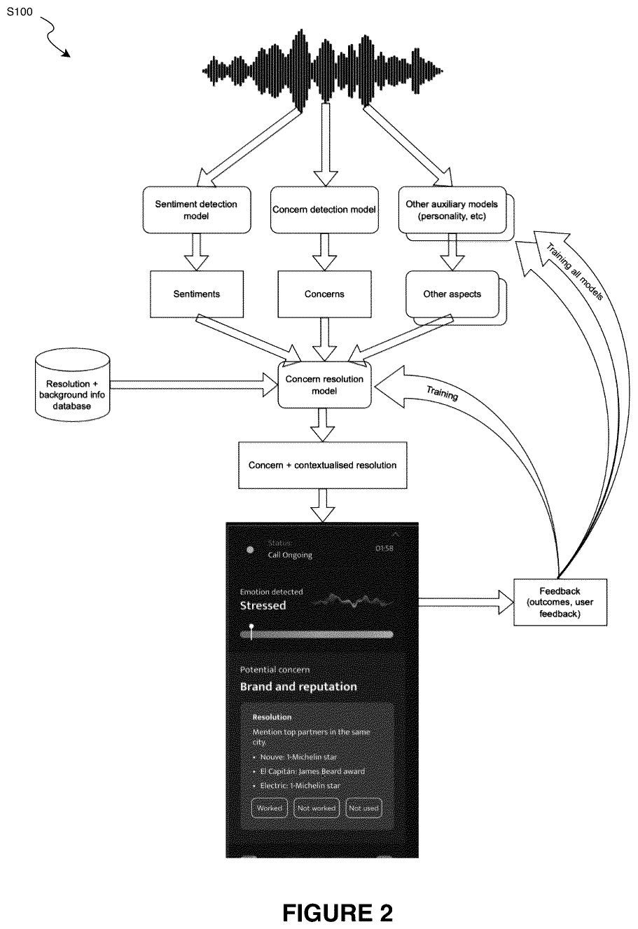

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Methods

As shown in the FIGURES, a method S100 includes, during a first time period, for each entity (e.g., restaurant) in a population of entities: accessing sets of entity data corresponding to the entity and published by a set of sources; aggregating the sets of entity data into a data container, in a set of data containers, associated with the entity; defining a set of attributes representing the entity based on the sets of entity data; and classifying the entity into a cluster of entities—in a set of clusters of entities—based on the set of attributes.

The method S100 also includes, during a second time period succeeding the first time period, for a first organization (e.g., company) characterized by a first organization type (e.g., food delivery, food distribution): accessing a first data container in the set of data containers, the first data container associated with a first entity in the population of entities and defining a first set of attributes representing the first entity, the first entity classified in a first cluster of entities in the set of clusters of entities.

The method S100 further includes: accessing a first model correlating concepts (e.g., subjects, concerns), related to entities in the first cluster of entities and organizations characterized by the first organization type, with responses predicted most likely to improve sentiment associated with the concepts; based on the first set of attributes and the first model, identifying a first set of concepts related to the first entity and associated with initial sentiment values falling within a first range (e.g., “negative” sentiment); and, based on the first set of attributes and the first model, generating a first set of responses—corresponding to the first set of concepts—predicted to result in subsequent sentiment values falling within a second range (e.g., “positive” sentiment).

The method S100 further includes, during a third time period succeeding the second time period, during a telecommunication session between a first device associated with the first organization and a second device associated with the first entity: accessing a first set of audio data in an audio data stream of the telecommunication session; detecting a first set of language signals based on the first set of audio data; accessing a second model correlating language signals with concepts, in the first set of concepts, and sentiment values associated with concepts; based on the second model, correlating the first set of language signals with a first concept, in the first set of concepts, and a third sentiment value associated with the first concept; based on the first concept and the third sentiment value, identifying a first subset of responses, in the first set of responses, predicted to result in a fourth sentiment value associated with the first concept, the fourth sentiment value exceeding the third sentiment value; generating a notification specifying the first concept and the first subset of responses; and serving the notification at the first device.

### 2. Applications

Generally, Blocks of the method S100 can be executed by a computer system (hereinafter “the system”): to aggregate data associated with an entity (e.g., company, merchant, restaurant) from a set of discrete sources; to unify these data into a data container defining a set of attributes representing the entity; to classify the entity with a cluster of entities based on the set of attributes; to access a model associated with the cluster of entities and correlating concerns with responses predicted to resolve these concerns; to generate a report specifying a subset of concerns related to the entity and a subset of responses corresponding to the set of concerns based on the set of attributes and the model; and to serve the report at a device of an agent affiliated with an organization (e.g., food delivery company).

Accordingly, Blocks of the method S100 can be executed by the system: to identify potential sales concerns related to the entity, such as in real-time during a telecommunication session (e.g., Voice over Internet Protocol (VOIP) call, video teleconference); to generate suggested responses—specific to the entity and the organization—that resolve these potential sales concerns; and to serve these potential sales concerns and suggested responses at the device of the agent in real-time (e.g., with a delay or latency of less than 1 or 2 seconds) during the telecommunication session. Therefore, the system can enable the agent to address potential sales concerns—raised explicitly by a partner (e.g., owner, manager) affiliated with the entity or inferred from sentiment or comments made by the partner—directly and in real-time during an active telecommunication session with the partner by presenting suggested responses and/or supporting data in real-time during the telecommunication session. Thus, the system can execute Blocks of the method S100 to support improved interaction between the agent and the partner, thereby increasing a likelihood that the entity will engage the organization, increasing sales efficiency, and/or improving partner relationships.

### 2.1 Real-Time Concern Resolution

Additionally, Blocks of the method S100 can be executed by the system, during the telecommunication session: to access a set of audio data in a live audio data stream of the telecommunication session, such as via an application programming interface (API) of an application hosting the telecommunication session; to detect a concept and a sentiment—exhibited by the partner—toward the concept based on the set of audio data; to identify a pre-generated response (or a subset of pre-generated responses) related to the entity; and to serve a real-time notification at the first device of the agent, the notification specifying the concept, the pre-generated response, the sentiment, and/or supporting data.

Accordingly, Blocks of the method S100 can be executed by the system, in real-time: to detect a concern raised by the partner during the telecommunication session; to identify a pre-generated response predicted to resolve the concern; and to serve a notification at the first device of the agent, the notification specifying the concern, the pre-generated response, the sentiment, and/or the supporting data. Therefore, the system can dynamically assist the agent—in real-time—based on the conversation during the telecommunication session to increase the likelihood for the agent to complete a sales process resulting in a sale between the organization and the entity.

### 2.3 Variations

The method S100 as described herein is executed by the system to: predict a set of concerns related to a restaurant; generate a set of responses predicted to resolve the set of concerns; and to serve the set of concerns and the set of responses to a device of an agent affiliated with an organization seeking to provide services to the restaurant. However, the system can similarly execute Blocks of the method S100 to: predict a set of concerns related to a restaurant; generate a set of responses predicted to resolve the set of concerns; and serve the concerns and the responses to a device of a user (e.g., owner, manager) affiliated with the restaurant.

Additionally, the method S100 as described herein is executed by the system to: aggregate data associated with a restaurant; predict a set of concerns related to the restaurant based on the data; generate a set of responses predicted to resolve the set of concerns; and to serve the set of concerns and the set of responses to a device of an agent affiliated with a food delivery company seeking to provide services to the restaurant. However, the system can similarly execute Blocks of the method S100 to: aggregate data associated with other merchants in other industries (e.g., auto repair companies, clothing retailers); predict concerns related to these merchants based on the data; generate responses predicted to resolve these concerns; and serve the concerns and the responses to devices of agents affiliated with organizations related to the other industries (e.g., distribution, point-of-sale).

Furthermore, the method S100 as described herein is executed by the system: to access a set of audio data in a live audio data stream of the telecommunication session; and to detect a concept and a sentiment—exhibited by the partner—toward the concept based on the set of audio data. However, the system can similarly execute Blocks of the method S100: to access a set of video data (or audiovisual data) in a live audiovisual data stream of the telecommunication session; and to detect a concept and a sentiment—exhibited by the partner—toward the concept based on the set of video data.

The method S100 as described herein is executed by the system to implement a set of models (e.g., resolution model, language model, concept model). However, the system can similarly execute Blocks of the method S100 to implement a subset of models (or a single model): to correlate concepts with responses predicted to resolve these concepts; to correlate audio data with language signals; and to correlate language signals with concepts during a telecommunication session.

### 3. Terms

Generally, an “organization” as referred to herein is a business (e.g., food delivery, distributor) accessing and/or utilizing the system.

Generally, an “agent” as referred to herein is a user (e.g., analyst, salesperson, support staff) affiliated with the organization.

Generally, an “entity” as referred to herein is a company (e.g., merchant, restaurant) that is a prospective customer or an existing customer of the organization.

Generally, a “partner” as referred to herein is a user (e.g., owner, manager) affiliated with the entity.

Generally, an “opportunity” as referred to herein is a discrete instance of a sales process between the organization and an entity.

Generally, a “closed-won opportunity” as referred to herein is an opportunity characterized by a completed sales process and resulting in a sale between the organization and the entity.

Generally, a “closed-lost opportunity” as referred to herein is an opportunity characterized by a completed sales process and resulting in absence of a sale between the organization and the entity.

### 4. Data Ingestion

Generally, for each entity in a population of entities, the system can: access sets of entity data corresponding to the entity and published by a set of sources; aggregate the sets of entity data into a data container, in a set of data containers, associated with the entity; define a set of attributes representing the entity based on the sets of entity data; and classify the entity into a cluster of entities—in a set of clusters of entities—based on the set of attributes.

### 4.1 Data Aggregation

Generally, the system can: access sets of entity data published by a set of sources; and aggregate these sets of entity data into a data container associated with the entity.

In one implementation, for each source in the set of sources, the system can access a set of entity data associated with the entity and published by the source, the set of entity data including name, physical location (e.g., address, region), contact information (e.g., phone number, email address), web address, operating hours, peak business hours, genre(s) (e.g., gastropub, Italian cuisine, fine dining, take-out), price range, product or service descriptions (e.g., menu, amenities), product images, specialties, awards and recognition, reviews, ratings, health score, promotions, license information, and/or point-of-sale information, etc. The system can aggregate each set of entity data into a data container (e.g., data structure) associated with the entity.

In one example, the system accesses a first set of entity data—corresponding to a first entity and published by a first source—in the set of sources—such as a website affiliated with the first entity, a search engine, a media source (e.g., news media, blog, podcast), social media, third-party website publishing information (e.g., reviews, menu, images) associated with the entity, government website, food ordering tool (e.g., food delivery website, food delivery application), etc.

In another example, the system accesses a second set of entity data published by a second source—in the set of sources—including a private data repository (or a set of private data repositories) storing data associated with a population of entities including the first entity.

In these examples, the system aggregates the first set of entity data and the second set of entity data into a first data container associated with the first entity.

### 4.1.1 Data Correlation and Unification

In one implementation, the system can: correlate (or normalize) analogous (e.g., identical, similar) entity data—published by different sources and identified by the system as corresponding to the same entity—and compile correlated entity data into the data container associated with the entity.

For example, the system can: detect a first genre value (e.g., denoted “Szechuan Chinese”) corresponding to a first entity (e.g., Chinese restaurant) in a first set of entity data published by a first source (e.g., third-party website); detect a second genre value (e.g., denoted “Sichuan (Chinese)”) corresponding to the first entity in a second set of entity data published by a second source (e.g., website affiliated with the restaurant); and normalize the first genre value and the second genre value into a normalized genre value (e.g., denoted “Sichuan Chinese”). In this example, the system can store the normalized genre value in a first data container associated with the first entity.

Accordingly, the system can consolidate entity data—published by different sources—into one representation of an entity utilizing a consistent format and lexicon, thereby enabling the system to define a complete and accurate set of attributes for this entity.

### 4.1.2 Attributes

In one implementation, the system can: define a set of attributes representing the entity based on the sets of entity data (and/or the correlated entity data) aggregated into the data container; and store the set of attributes in the data container. The system can define the set of attributes, based on the sets of entity data, including: name, physical location (e.g., address, geographic region), contact information (e.g., phone number, email address), web address, operating hours, peak business hours, genre(s) (e.g., gastropub, Italian cuisine, fine dining, take-out), price range, product or service descriptions (e.g., menu, amenities), specialties, awards and recognition, rating, health score, promotions, license information, and/or point-of-sale information, etc.

For example, the system can: detect a first name value (“Sichuan Taste”) corresponding to a first entity in a first set of entity data; detect a second name value (e.g., “Sichuan Taste”) corresponding to the first entity in a second set of entity data; detect a first normalized genre value (e.g., “Sichuan Chinese”); define a first attribute (e.g., “Sichuan Taste”), in a set of attributes representing the first entity, based on the first name value and the second name value; define a second attribute (e.g., “Sichuan Chinese”), in the set of attributes, based on the normalized genre value; and store the first attribute and the second attribute in the data container.

### 4.1.3 Population of Entities

Generally, the system can implement similar methods and techniques, for each entity in a population of entities: to access sets of entity data, associated with the entity, from the set of sources; aggregate these sets of entity data into a data container associated with the entity; correlate (or normalize) analogous entity data and compile correlated entity data into the data container; define a set of attributes representing the entity based on the sets of entity data and/or the correlated entity data; and store the set of attributes in the data container.

Therefore, the system can generate a population of data containers corresponding to the population of entities, each data container in the population of data containers defining a complete and accurate set of attributes representing the entity.

### 4.2 Entity Classification

In one implementation, the system can classify an entity into a cluster of entities—in a set of clusters of entities—based on a set of attributes representing the entity.

In one example, the system: accesses a first set of attributes representing a first restaurant; detects a first genre attribute (e.g., “Italian”) in the first set of attributes; detects a first price range attribute (e.g., “$$$$”) in the first set of attributes; detects a first region attribute (“Los Angeles”); and classifies the first restaurant in a first cluster representing very expensive Italian restaurants in Los Angeles. The system classifies the first restaurant into additional clusters based on the first set of attributes.

In another example, the system: accesses a second set of attributes representing a second restaurant; detects a second genre attribute (e.g., “Chinese”) in the second set of attributes; detects a second price range attribute (e.g., “$”) in the second set of attributes; and classifies the second restaurant in a second cluster representing inexpensive Chinese restaurants. The system classifies the second restaurant into additional clusters based on the second set of attributes, such as a third cluster representing inexpensive restaurants and a fourth cluster representing Chinese restaurants.

The system can implement similar methods and techniques to classify each entity—in a population of entities—into a cluster of entities (or a set of clusters of entities) based on a set of attributes associated with the entity.

### 5. Concern Resolution

Generally, a first device (e.g., telephone, mobile phone, laptop computer, desktop computer, tablet computer, wearable device) of an agent (e.g., user, salesperson, support staff) affiliated with an organization characterized by a first organization type (e.g., food delivery company, food distribution company) can initiate a telecommunication session (e.g., phone call, VOIP call, audio teleconference, video teleconference) between the first device and a second device of a partner (e.g., owner, manager) affiliated with an entity (e.g., restaurant), such as a prospective entity with which the organization is seeking to engage and/or for which the organization is seeking to provide services.

During a time period preceding the telecommunication session, the system can: access a set of attributes associated with the entity; identify the entity as classified in a first cluster of entities; and access a first model (or “resolution model”) correlating concepts (e.g., subjects, concerns), related to entities in the first cluster of entities and organizations characterized by the first organization type, with responses predicted most likely to yield a closed—won opportunity—between entities in the first cluster of entities and organizations characterized by the first organization type—and/or improve sentiment associated with these concepts. Based on the set of attributes and the resolution model, the system can: identify a set of concepts related to the entity; and generate a set of responses corresponding to the set of concepts and predicted to yield a closed-won opportunity with the entity. Additionally, the system can: identify a subset of concepts—in the set of concepts—associated with initial sentiment values falling within a first range (e.g., “negative” sentiment); and generate a subset of responses, in the set of responses, corresponding to the subset of concepts and predicted to result in subsequent sentiment values falling within a second range (e.g., “positive” sentiment, “neutral” sentiment).

Furthermore, the system can: generate a report indicating the set of concepts, including the subset of concepts associated with initial sentiment values falling within the first range (or “concerns”); and the set of responses predicted to yield a closed-won opportunity with the entity and/or result in subsequent sentiment values falling within the second range (or “resolutions”); and serve the report at the first device, such as during a time period preceding the telecommunication session.

Accordingly, the system can: identify concepts associated with initial sentiment values falling within the first range as potential sales concerns related to the entity; generate suggested responses—specific to the entity—that resolve these potential sales concerns; and serve these potential sales concerns and suggested responses to the device operated by the agent. Therefore, the system can enable the agent to utilize the suggested responses—in response to the potential sales concerns being raised during a telecommunication session with the partner—to improve an interaction between the agent and the partner and to increase a likelihood for the organization to engage (or complete a sale) with the prospective entity based on this interaction.

### 5.1 Resolution Model Generation

Generally, the system can generate a resolution model correlating concepts (e.g., subjects, concerns) with responses predicted most likely to: yield a closed-won opportunity with the entity; improve sentiment toward these concepts; and/or resolve concepts identified as concerns (e.g., concepts associated with an initial sentiment value falling within a predefined range). More specifically, the system can generate the resolution model correlating a concept, associated with an initial sentiment value, with a set of responses most likely to result in a subsequent sentiment value—associated with the concept—exceeding the initial sentiment value.

In one implementation, the system can access a first training dataset defining a first population of concepts identified as concerns and associated with: entities in a first cluster of entities in a set of clusters of entities; entities exhibiting a first subset of attributes; and/or organizations characterized by a first organization type. The system can access the first training dataset further defining, for each concern in the first population of concepts: a first subset of responses labeled as resolving the concern; and a second subset of responses labeled as failing to resolve the concern. In this implementation, the system can train the resolution model based on the first training dataset, thereby enabling the system to: correlate attributes of an entity and/or classification of the entity—within the first cluster of entities—with concepts identified as concerns; and correlate the concerns with responses predicted most likely to resolve these concerns.

In another implementation, the system can access a second training dataset defining a second population of concepts associated with initial sentiment values falling within a first range associated with “negative” sentiment and associated with: entities in the first cluster of entities; entities exhibiting a second subset of attributes; and/or organizations characterized by the first organization type. The system can access the second training dataset further defining, for each concept in the second population of concepts: a third subset of responses—corresponding to the concept—that map to a subsequent sentiment value falling within a second range associated with a “neutral” sentiment; a fourth subset of responses, corresponding to the concept, that map to a subsequent sentiment value falling within a third range associated with “positive” sentiment”; and a fifth subset of responses, corresponding to the concept, that map to a subsequent sentiment value within the first range. In this implementation, the system can train the resolution model based on the second training dataset, thereby enabling the system to: correlate attributes of an entity and/or classification of the entity—within the first cluster of entities—with concepts associated with “negative” sentiment; and correlate the concepts with responses predicted most likely to (maximally) improve sentiment toward these concepts.

Additionally or alternatively, the system can train the resolution model based on other training data correlating concepts—related to entities exhibiting the first subset of attributes, exhibiting the second subset of attributes, and/or classified into the first cluster of entities—with responses for these concepts based on other features (e.g., responses most likely to result in completion of a sale).

In one implementation, the system can access a third training dataset defining a third population of concepts associated with: entities in the first cluster of entities; entities exhibiting the first subset of attributes; and/or organizations characterized by the first organization type. The system can access the third training dataset further defining, for each concept in the third population of concepts: a first subset of responses labeled as yielding (or contributing to) a closed-won opportunity; and a second subset of responses labeled as yielding (or contributing to) a closed-lost opportunity. In this implementation, the system can train the resolution model based on the third training dataset, thereby enabling the system to correlate concepts with responses predicted most likely to yield a closed-won opportunity.

The system can implement similar methods and techniques to: access training datasets correlating concepts, related to entities in other clusters of entities in the set of clusters of entities, with responses to these concepts based on various features; and to train the resolution model based on these training datasets.

### 5.1.1 Entity-Specific Model

In one implementation, the system can further train the resolution model based on information associated with an entity (or associated with an individual affiliated with the entity). For example, the system can further train the resolution model based on: a first transcript of a first telecommunication session between a manager of a first restaurant and a first agent of a first food delivery company; and a second transcript of a second telecommunication session between the manager of the first restaurant and a second agent of a second food distribution company. The first transcript can indicate: a first subset of responses labeled as resolving a respective concern and/or improving sentiment exhibited by the manager; and a second subset of responses labeled as failing to resolve a respective concern and/or failing to improve sentiment exhibited by the manager. Similarly, the second transcript can indicate: a third subset of responses labeled as resolving a respective concern and/or improving sentiment exhibited by the manager; and a fourth subset of responses labeled as failing to resolve a respective concern and/or failing to improve sentiment exhibited by the manager. Additionally, these transcripts can further indicate: a fifth subset of responses labeled as yielding (or contributing to) a closed-won opportunity; and a sixth subset of responses labeled as yielding (or contributing to) a closed-lost opportunity.

Accordingly, the system can generate a resolution model correlating concepts with responses specific to an entity or an individual affiliated with the entity, thereby enabling an agent affiliated with the organization to utilize these responses during a telecommunication session with the individual to improve an interaction with the individual and to increase a likelihood for the organization to engage (or complete a sale) with the entity based on this interaction.

### 5.1.2 Organization-Specific Model

In another implementation, the system can further train the resolution model based on information associated with an organization (e.g., historical sales information, a company handbook).

In one example, the system further trains the resolution model based on historical sales information associated with the organization (e.g., the organization exhibits a 75% market share for food delivery associated with Chinese takeout restaurants in a particular city). In this example, the system trains the resolution model to further correlate concepts with responses citing the historical sales information.

In another example, the system further trains the resolution model based on a company handbook for the organization specifying responses exhibiting a particular format and lexicon. In this example, the system trains the resolution model to further correlate concepts with responses exhibiting the particular format and lexicon.

Accordingly, the system can generate a resolution model correlating concepts with responses specific to an organization, thereby enabling an agent affiliated with the organization to utilize these responses during a telecommunication session to distinguish the organization from competitors and increase a likelihood of completing a sale.

### 5.3 Concept Identification

Generally, the system can identify a set of concepts related to the entity based on the resolution model.

In one implementation, for an organization characterized by a first organization type, the system can: access a data container associated with an entity, the data container defining a set of attributes representing the entity; and identify a set of concepts—related to the entity and/or organizations characterized by the first organization type—based on the set of attributes and the resolution model. More specifically, based on the set of attributes and the resolution model, the system can identify a concept—associated with an initial sentiment value falling within a first range corresponding to “negative” sentiment—as a concern related to the entity.

For example, the system can access a first data container—associated with a first restaurant—defining a first set of attributes representing the first restaurant; identify a first concern related to the first restaurant based on the first set of attributes and the resolution model correlating a second subset of attributes to the first concern, the first set of attributes including the second subset of attributes; and identify a second concern related to the first restaurant based on the first set of attributes and the resolution model correlating a third subset of attributes to the second concern, the first set of attributes including the third subset of attributes.

Additionally or alternatively, the system can identify the set of concepts related to the entity based on the resolution model, classification of the entity within a particular cluster of entities, and an organization type.

For example, for a first organization characterized by a first organization type (e.g., a food delivery company), based on the resolution model and the first restaurant in a first cluster of restaurants associated with very expensive Italian restaurants in Los Angeles, the system can identify a second concern related to the first restaurant, such as low demand for food delivery from very expensive Italian restaurants in Los Angeles.

In another implementation, the system can store the set of concepts related to the entity in a data container associated with the entity and/or in another data structure associated with the entity.

### 5.4 Response Generation

Generally, for an organization characterized by a first organization type, the system can generate a set of responses—corresponding to a set of concepts—based on the set of attributes and the resolution model. Additionally, the system can generate the set of responses based on the first organization type, attributes representing other entities in the population of entities, other information associated with the population of entities, and/or information associated with other organizations.

In one implementation, based on the set of attributes and the resolution model, the system can generate a response—corresponding to a concern in the set of concepts related to an entity—predicted to yield a closed-won opportunity with the entity and/or result in a subsequent sentiment value exceeding an initial sentiment value. More specifically, based on the set of attributes and the resolution model, the system can generate the response corresponding to the concern and predicted to result in the subsequent sentiment value falling within a second range (e.g., “positive” sentiment, “neutral” sentiment).

For example, for a first organization (e.g., “SuperEats”) characterized by a first organization type (e.g., a food delivery company), the system can generate a first response corresponding to a first concern of “low demand for food delivery from very expensive Italian restaurants in Los Angeles” related to a first restaurant, in a first cluster of restaurants associated with very expensive Italian restaurants and represented by a first set of attributes (e.g., located at 123 Main Street in Los Angeles), based on the first set of attributes, the resolution model, and the first organization type. In this example, based on the first set of attributes, the resolution model, and the first organization type, the system can generate the first response as “SuperEats has partnered with five other very expensive Italian restaurants within five miles of your location for food delivery.” Furthermore, the system can generate the first response predicted to: yield a closed-won opportunity with the first restaurant; resolve the first concern; and result in a subsequent sentiment value falling within a range corresponding to “positive” sentiment. The system can generate additional responses—corresponding to the first concern—predicted to: yield the closed-won opportunity with the first restaurant; resolve the first concern; and result in a subsequent sentiment value falling within the range corresponding to “positive” sentiment.

In another implementation, the system can store the set of responses—corresponding to the set of concepts related to the entity—in a data container associated with the entity and/or in another data structure associated with the entity.

### 5.5 Report

Generally, the system can: generate a report associated with an entity; and serve the report at a first device. For example, the system can generate a report associated with a restaurant; and serve the report at a device of an agent affiliated with a food delivery company, such as during a time period preceding a telecommunication session between the agent and an owner of the restaurant.

In one implementation, the system can generate a report indicating: the set of concepts (e.g., concerns) related to an entity; and the set of responses corresponding to the set of concepts. More specifically, the system can: rank the set of concepts inversely proportional to initial sentiment value (e.g., a concept exhibiting a lowest initial sentiment value ranked highest) as a ranked set of concepts; select a subset of concepts in the ranked set of concepts (e.g., three concepts exhibiting highest rank); and generate the report indicating the subset of concepts and a subset of responses corresponding to the subset of concepts.

In another implementation, the system can: access a data container—associated with an entity—defining a set of attributes representing the entity; and generate the report specifying a set of sales insights associated with the entity based on the set of attributes.

For example, the system can access a first data container—associated with a first restaurant—defining a first set of attributes representing the first restaurant. Based on the first set of attributes (e.g., peak business hours, specialties, product or service descriptions, promotions), the system can generate the report specifying a set of sales insights of the first restaurant, such as: a restaurant summary; signature dishes; awards and recognition; dining strengths; dining weaknesses; operational strengths; operational weaknesses; and/or suggested times to initiate a telecommunication session; etc.

Additionally, the system can generate the report further specifying the set of attributes (or a subset of attributes in the set of attributes). For example, the system can generate the report further specifying: name; physical location (e.g., address, region); contact information (e.g., phone number, email address); web address; operating hours; peak business hours; genre(s) (e.g., gastropub, Italian cuisine, fine dining, take-out), price range; etc.

In one implementation, the system can serve the report to a device (e.g., mobile phone, laptop computer, tablet computer, desktop computer) of an agent affiliated with an organization. For example, the system can automatically serve the report to the device during a time period preceding a telecommunication session between the agent and a partner affiliated with the entity.

Accordingly, the system can automatically generate and serve a report: specifying background information of an entity; and indicating a set of concise responses—corresponding to a set of concerns for the entity—that is predicted to resolve the concerns and includes details that are specific to the particular entity and an organization, thereby simplifying a preparation process of the agent for the telecommunication session between the agent and the partner affiliated with the entity.

### 6. Real-Time Concern Resolution

Generally, during a telecommunication session between a first device of an agent affiliated with an organization (e.g., food delivery company) and a second device of a partner (e.g., manager) affiliated with an entity (e.g., restaurant), the system can: access a first set of audio data in an audio data stream of the telecommunication session; detect a first set of language signals based on the first set of audio data; access a second model (e.g., concept model) correlating language signals with concepts in a set of concepts (e.g., a first set of concepts related to the entity and previously identified based on the resolution model); based on the second model, correlate the first set of language signals with a first concept in the set of concepts; identify a first subset of responses, in a set of responses (e.g., a first set of responses corresponding to the first set of concepts and previously generated based on the resolution model), corresponding to the first concept and predicted to improve sentiment—exhibited by the partner—toward the first concept; generate a notification specifying the first concept and the first subset of responses; and serve the notification at the first device.

Accordingly, the system can: detect a concern raised by the partner; identify a subset of pre-generated responses predicted to resolve the concern; and serve a notification—to the first device of the agent—specifying the concern and the subset of pre-generated responses. Therefore, the system can dynamically assist the agent in real-time based on conversation during the telecommunication session.

### 6.1 Concept Detection

In one implementation, the system can access a set of audio data in an audio data stream of a telecommunication session. More specifically, the system can access a set of audio data in a live audio stream of an active telecommunication session. For example, the system can access—via an API of an application hosting the active telecommunication session—a first set of audio data including a predefined number of chunks (e.g., 4 chunks in a sliding window) of the audio data stream, each chunk exhibiting a predefined quantity of samples.

In another implementation, the system can detect a set of language signals (e.g., phonemes, words, phrases, speech patterns) based on the set of audio data. More specifically, the system can detect the set of language signals based on the set of audio data and a model (e.g., language model) correlating audio data with phonemes, words, phrases, and/or speech patterns, etc.

In one variation, the system can detect the set of language signals based on the set of audio data by: transcribing the set of audio data into a text string; and detecting the set of language signals based on the text string.

In one implementation, the system can access a second model (e.g., concept model) correlating language signals with concepts (e.g., concepts previously identified based on the resolution model) related to an entity. More specifically, the system can access a concept model correlating language signals with: concepts related to an entity; and sentiment values associated with these concepts.

In this implementation, based on the concept model, the system can correlate the set of language signals with a particular concept and an initial sentiment value associated with this particular concept.

For example, the system can: access a first set of audio data in the audio data stream; detect a first set of language signals based on the first set of audio data; and, based on the concept model, correlate the first set of language signals with a first concern (e.g., a signature fried lobster dish degrades in quality due to delivery) and an initial sentiment value—associated with the first concern—falling within a first range corresponding to “negative” sentiment.

Additionally or alternatively, based on the concept model, the system can correlate the set of language signals—and/or a detected set of non-verbal signals—with a set of parameters including: a first personality exhibited by the partner; a second personality exhibited by the agent; a first language proficiency exhibited by the partner; a second language proficiency exhibited by the agent; a first politeness level exhibited by the partner; a second politeness level exhibited by the agent; a first proportion of conversation associated with business related concepts; and/or a second proportion of conversation associated with non-business related concepts, etc.

### 7.2 Response Identification

In one implementation, in response to correlating a set of language signals with a particular concept and the initial sentiment value, the system can identify a subset of responses, in a set of responses (e.g., a set of responses previously generated based on the resolution model) related to the entity, predicted to yield a closed-won opportunity with the entity and/or result in a subsequent sentiment value—exhibited by the partner toward the particular concept—exceeding the initial sentiment value. Additionally, the system can identify the subset of responses based on the set of parameters (or a subset of parameters in the set of parameters).

More specifically, in response to correlating the set of language signals with the particular concept related to the entity, the system can access a subset of responses corresponding to the particular concept stored in a data container (or other data structure) associated with the entity.

For example, in response to correlating a first set of language signals with a first concern (e.g., a signature fried lobster dish degrades in quality due to delivery) related to a first restaurant, the system can access a first data container associated with the first restaurant and storing a first subset of responses corresponding to the first concern (e.g., enumerate other signature menu items that maintain quality during delivery).

Accordingly, by utilizing pre-generated responses (i.e., responses generated during a time period preceding the telecommunication session) corresponding to a concern, the system can reduce a total amount of real-time processing required to detect the concern and output a response corresponding to the concern, thereby reducing latency.

In one variation, in response to correlating the set of language signals with the particular concept related to the entity, the system can generate a second subset of responses—corresponding to the particular concept—based on a first subset of responses stored in the data container associated with the entity. For example, the system can generate the second subset of responses based on the first subset of responses by modifying the first subset of responses based on: other concepts detected during the telecommunication session; other responses identified during the telecommunication session; and/or sentiment (or emotion state) exhibited by the partner during the telecommunication session; etc.

### 7.3 Visualization

In one implementation, the system can generate a notification specifying the particular concept and the subset of responses corresponding to the particular concept. Additionally, the system can generate the notification further indicating an initial sentiment value (or emotion state) exhibited by the partner and associated with the particular concept. Furthermore, the system can generate the notification further specifying supporting data associated with the particular concept, the subset of responses, the emotion state, and/or other information. The system can serve the notification at the first device of the agent.

### 7.4 Continuous Processing

Generally, the system can repeat the foregoing processes to: access a second set of audio data in the audio stream of the telecommunication session; detect a second set of language signals based on the second set of audio data; correlate the second set of language signals with a second concept based on the concept model; identify a second subset of responses, in a set of responses (e.g., a set of responses previously generated based on the resolution model), corresponding to the second concept and predicted to yield a closed-won opportunity with the entity and/or improve sentiment—exhibited by the partner—toward the second concept; generate a second notification specifying the second concept and the second subset of responses; and serve the second notification at the first device.

In one example, the system identifies the second subset of responses including a first response to confirm agreement to complete a sale. In another example, the system identifies the second subset of responses including a second response to confirm a follow-up action (or a set of follow-up actions) during a time period succeeding the telecommunication session.

Accordingly, the system can serve a series of responses—based on feedback from the partner and predicted most likely to yield a closed-won opportunity with the entity—to the agent during the telecommunication session, thereby guiding the agent toward conclusion of a sale.

### 7.5 Post-hoc Report

In one implementation, in response to completion of the telecommunication session, the system can generate a report indicating: a summary of the telecommunication session, an evaluation of agent performance, and/or follow-up actions, etc.

### 8. Model Update

In one implementation, the system can receive, from the first device of the agent, indications that a first group of responses—specified during the telecommunication session—yielded (or contributed to) a closed-won opportunity, improved sentiment exhibited by the partner, and/or resolved concerns associated with the first group of responses. Additionally, the system can receive indications that a second group of responses, specified during the telecommunication session, yielded (or contributed to) a closed-lost opportunity, failed to improve sentiment exhibited by the partner, and/or failed to resolve concerns associated with the first group of responses. In this implementation, the system can update (e.g., re-train) the resolution model based on these indications.

The system can implement similar methods and techniques to update the concern model and/or the language model based on feedback from the first device of the agent or other information.

### 9. Data Container Update

Generally, for each entity in a population of entities, the system can periodically (e.g., weekly, monthly): access sets of entity data corresponding to the entity and published by a set of sources; and aggregate the sets of entity data into a data container, in a set of data containers, associated with the entity. The system can update a set of attributes representing the entity based on the sets of entity data; and classify the entity into a cluster of entities—in a set of clusters of entities—based on the set of attributes.

Additionally, for each entity in the set of entities, the system can: automatically update the set of concerns related to the entity and/or the set of responses corresponding to the set of concerns based on the updated data container, the updated resolution model, the updated concern model, and/or the updated language model, etc.; and store the set of concerns and/or the set of responses in the updated data container.

### 10. Conclusion

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
during a first time period, for each entity in a population of entities:
accessing sets of entity data corresponding to the entity and published by a set of sources;
aggregating the sets of entity data into a data container, in a set of data containers, associated with the entity;
defining a set of attributes representing the entity based on the sets of entity data; and
classifying the entity into a cluster of entities in a set of clusters of entities based on the set of attributes;
during a second time period succeeding the first time period, for a first organization characterized by a first organization type:
accessing a first data container in the set of data containers, the first data container associated with a first entity in the population of entities and defining a first set of attributes representing the first entity, the first entity classified in a first cluster of entities in the set of clusters of entities;
accessing a first model correlating concepts, related to entities in the first cluster of entities and organizations characterized by the first organization type, with responses predicted most likely to improve sentiment associated with the concepts;
based on the first set of attributes and the first model, identifying a first set of concepts related to the first entity and associated with initial sentiment values falling within a first range; and
based on the first set of attributes and the first model, generating a first set of responses, corresponding to the first set of concepts, predicted to result in subsequent sentiment values falling within a second range; and
during a third time period succeeding the second time period, during a telecommunication session between a first device associated with the first organization and a second device associated with the first entity:
accessing a first set of audio data in an audio data stream of the telecommunication session;
detecting a first set of language signals based on the first set of audio data;
accessing a second model correlating language signals with concepts, in the first set of concepts, and sentiment values associated with concepts;
based on the second model, correlating the first set of language signals with a first concept, in the first set of concepts, and a third sentiment value associated with the first concept;
based on the first concept and the third sentiment value, identifying a first subset of responses, in the first set of responses, predicted to result in a fourth sentiment value associated with the first concept, the fourth sentiment value exceeding the third sentiment value;
generating a notification specifying the first concept and the first subset of responses; and
serving the notification at the first device.
